(19) United States
(12) Patent Application Publication
(10) Pub. No.: US 2025/0269800 A1
(43) Pub. Date: Aug. 28, 2025

(54) VEHICLE INTERIOR PART ATTACHING STRUCTURE

(71) Applicant: KOJIMA INDUSTRIES CORPORATION, Toyota-shi (JP)

(72) Inventor: Soma HIGASHITANI, Toyota-shi (JP)

(73) Assignee: KOJIMA INDUSTRIES CORPORATION, Toyota-shi (JP)

(21) Appl. No.: 19/064,852

(22) Filed: Feb. 27, 2025

(30) Foreign Application Priority Data
Feb. 28, 2024 (JP) 2024-028532

(51) Int. Cl. B60R 7/04; B60R 11/00

(52) U.S. Cl. CPC B60R 7/04; B60R 2011/0007; B60R 2011/0059

(57) ABSTRACT

A vehicle interior part attaching structure for attaching a vehicle interior part to a vehicle structural component may include a pair of openings formed in the vehicle structural component, and a box-shaped interior part main body and a bottom plate constituting the vehicle interior part. The interior part main body has a bottom opening, a pair of contacting portions, and a pair of engagement members having engagement portions. The engagement members are movably connected to the interior part main body via movably connecting mechanisms so as to move outward. The bottom plate includes pressing members formed therein. The pressing members are configured to move the engagement members outward when the bottom plate is fitted in the bottom opening of the interior part main body in a condition in which the interior part main body is disposed on the vehicle structural component.

### CROSS-REFERENCE TO RELATED APPLICATIONS

This application claims priority to a Japanese Patent Application serial number 2024-028532 filed Feb. 28, 2024, which is hereby incorporated herein by reference in its entirety for all purposes.

### BACKGROUND

The disclosure relates to a vehicle interior part attaching structure for attaching a vehicle interior part (e.g., a console box) to a vehicle structural component (e.g., a vehicle panel).

Generally, a vehicle (e.g., an automobile) includes a vehicle interior part (e.g., a console box) attached thereto. The vehicle interior part is connected to a vehicle structural component (e.g., a vehicle panel) attached to the vehicle by using bolts. Further, the vehicle interior part may be connected to the vehicle structural component by using clips instead of the bolts. Such a vehicle interior part attaching structure using the clips is taught, for example, by Japanese Laid-Open Patent Application No. 2005-306247 (JPA2005-306247). According to such an attaching structure taught by JPA2005-306247, the vehicle interior part can be connected to the vehicle structural component by simply inserting the clips formed in the vehicle interior part into engagement holes formed in the vehicle structural component. Therefore, the vehicle interior part can be easily and quickly connected to the vehicle structural component without using tools.

However, in the attaching structure taught by JPA2005-306247, the clips are simply inserted into the engagement holes, thereby connecting the vehicle interior part to the vehicle structural component. Therefore, the vehicle interior part may sometimes be rattled due to vibration of the vehicle.

Therefore, there is a need in the art for an improved vehicle interior part attaching structure.

### SUMMARY

In one aspect of the present disclosure, a vehicle interior part attaching structure for attaching a vehicle interior part to a vehicle structural component may include a pair of openings formed in the vehicle structural component, and a box-shaped interior part main body and a bottom plate constituting the vehicle interior part. The interior part main body has a bottom opening, a pair of contacting portions, and a pair of engagement members having engagement portions. The engagement members are movably connected to the interior part main body via movably connecting mechanisms so as to move outward. The bottom plate is configured to fit in the bottom opening of the interior part main body. The bottom plate includes pressing members formed therein. The pressing members are configured to move the engagement members outward when the bottom plate is fitted in the bottom opening of the interior part main body in a condition in which the interior part main body is disposed on the vehicle structural component, thereby bringing the engagement portions of the engagement members into contact with peripheral edges of the openings formed in the vehicle structural component such that the peripheral edges of the openings are sandwiched between the engagement portions and the contacting portions.

According to the structure, the vehicle interior part is attached to the vehicle structural component with the peripheral edges of the openings sandwiched between the engagement portions and the contacting portions. Therefore, the vehicle interior part can be stably held on the vehicle structural component without producing any rattling in vertical and horizontal directions.

Other objects, features and advantages of the present invention will be readily understood after reading the following detailed description together with the accompanying drawings and the claims.

### BRIEF DESCRIPTION OF THE DRAWINGS

FIG. 1 is a perspective view of a console box according to a first representative embodiment of the present disclosure, which illustrates a condition in which the console box is attached to a vehicle panel;

FIG. 2 is an exploded perspective view of the console box and the vehicle panel of FIG. 1;

FIG. 3 is an exploded bottom perspective view of the console box and the vehicle panel of FIG. 1;

FIG. 4 is a cross-sectional view of the console box and the vehicle panel of FIG. 1 taken along line IV-IV in FIG. 2;

FIG. 5 is a cross-sectional view of the console box and the vehicle panel of FIG. 1 taken along line V-V in FIG. 2, which illustrates a condition in which a console box main body of the console box is disposed on the vehicle panel and in which a bottom member of the console box is partly fitted in a bottom opening of the console box main body;

FIG. 6 is a cross-sectional view of the console box and the vehicle panel of FIG. 1 taken along line IV-IV in FIG. 2, which illustrates a condition in which the console box main body of the console box is disposed on the vehicle panel and in which the bottom member of the console box is partly fitted in the bottom opening of the console box main body;

FIG. 7 is a view similar to FIG. 5, in which the bottom member of the console box is fitted in the bottom opening of the console box main body;

FIG. 8 is a view similar to FIG. 6, in which the bottom member of the console box is fitted in the bottom opening of the console box main body;

FIG. 9 is an exploded cross-sectional view of a console box according to a second representative embodiment of the present disclosure attached to a vehicle panel, which is similar to the view shown in FIG. 4;

FIG. 10 is a cross-sectional view of the console box and the vehicle panel of FIG. 9, which illustrates a condition in which a console box main body of the console box is disposed on the vehicle panel and in which a bottom member of the console box is partly fitted in a bottom opening of the console box main body; and

FIG. 11 is a view similar to FIG. 10, in which the bottom member of the console box is fitted in the bottom opening of the console box main body.

### DETAILED DESCRIPTION

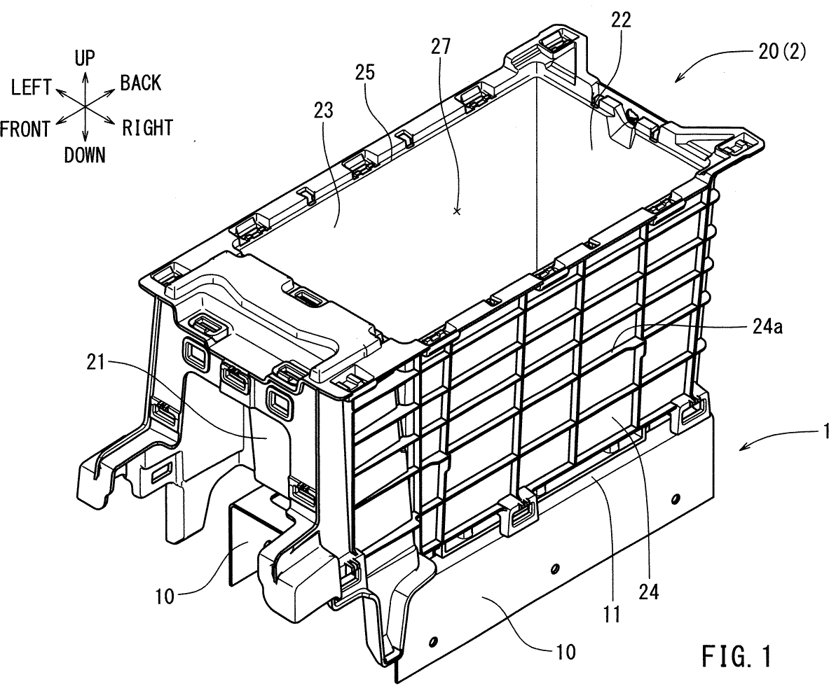

Detailed representative embodiments of the present disclosure are shown in FIGS. 1 to 11.

In the following, a first embodiment will be described in detail with reference to FIGS. 1 to 8. The first embodiment is directed to a console box attaching structure for attaching a console box 2 (a vehicle interior part) to a vehicle panel 1 (a vehicle structural component) of a vehicle (not shown) such as an automobile. Further, forward, backward, rightward, leftward, upward and downward directions described with reference to the figures may be defined as shown simply for descriptive purposes. However, such directions may substantially correspond to forward, backward, rightward, leftward, upward and downward directions of the vehicle.

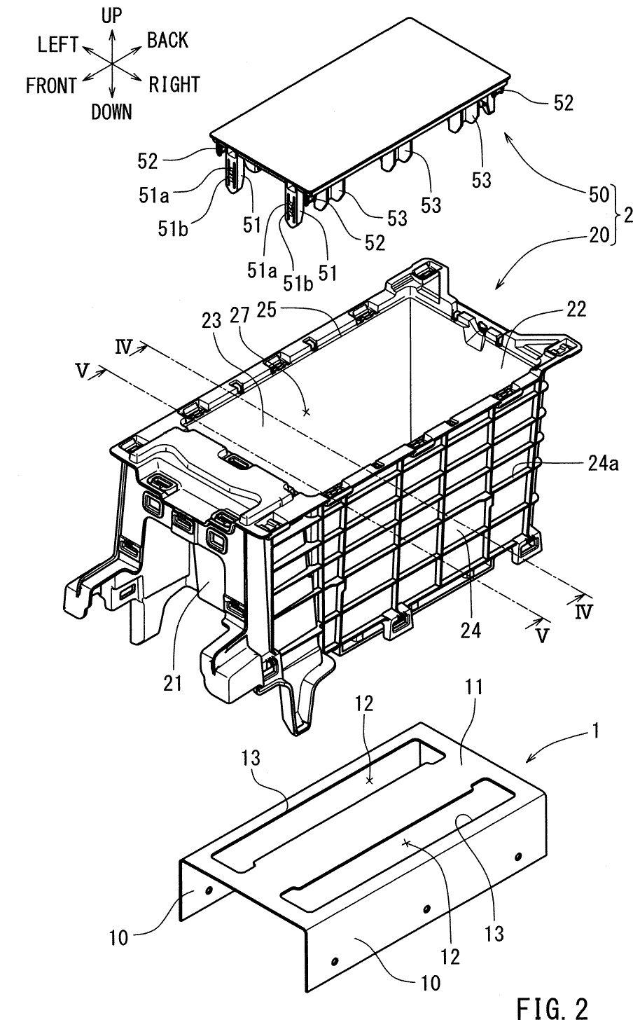

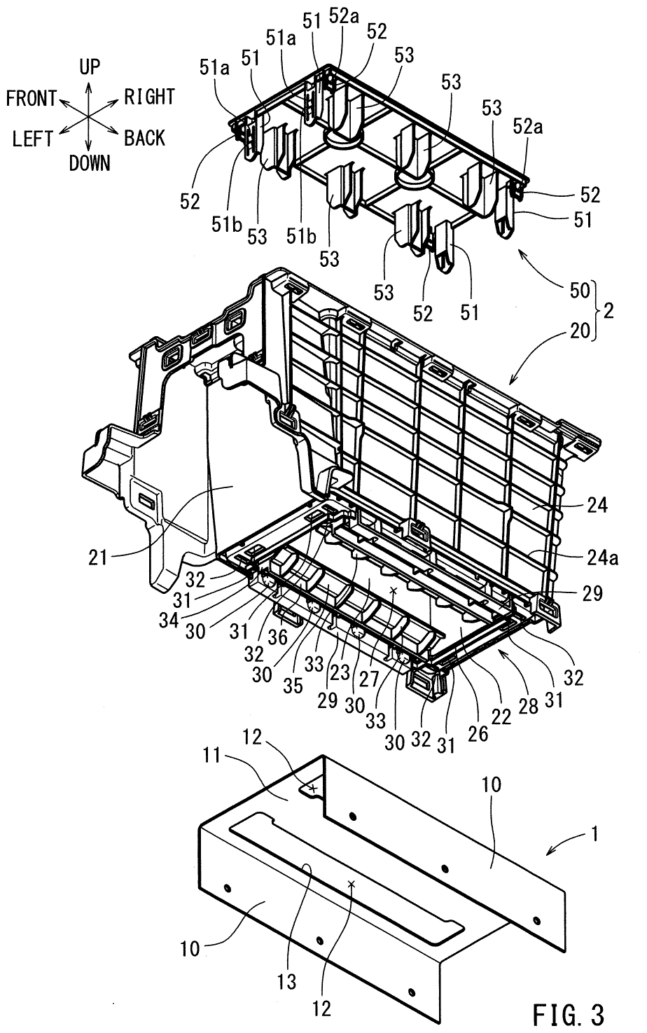

As shown in FIG. 1, the console box 2 is configured to be disposed on and attached to the vehicle panel 1. As shown in FIGS. 2 and 3, the vehicle panel 1 is a metal panel that is formed into a U-shape in cross section by bending. In particular, the vehicle panel 1 includes an upper wall 11 and a pair of (right and left) side walls 10. The upper wall 11 has a rectangular shape elongated in a front-back direction. Further, the upper wall 11 includes a pair of (right and left) elongated through holes or openings 12 formed therein and having rectangular shapes. The openings 12 penetrate the upper wall 11 in the thickness direction. Further, the openings 12 are arranged so as to extend along corresponding side walls 10.

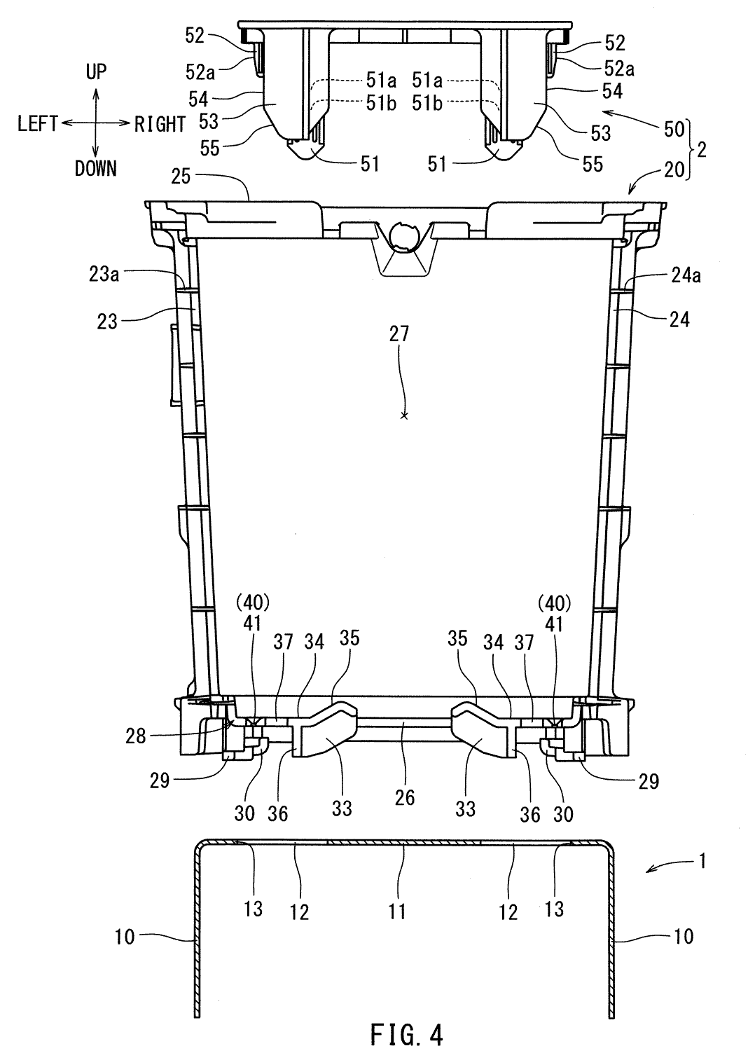

As shown in FIGS. 2 and 3, the console box 2 includes a console box main body 20, a bottom member 50, and a lid (not shown) that are separately formed. Further, the console box main body 20 is generally covered by a covering member (not shown). Each of the console box main body 20 and the bottom member 50 is integrally formed by integral molding of a hard synthetic resin. The console box main body 20 is a rectangular box-shaped member having a rectangular upper opening 25 and a rectangular lower or bottom opening 26. The console box main body 20 includes a front wall 21, a rear wall 22, a left wall 23, and a right wall 24. The left wall 23 has a grid-like rib 23a formed on an outer surface thereof (FIG. 4). Similarly, the right wall 24 has a grid-like rib 24a formed in an outer surface thereof. Thus, the rib 23a and the rib 24a may reinforce the left wall 23 and the right wall 24, thereby increasing rigidity of the console box main body 20.

As shown in FIGS. 3 and 4, the console box main body 20 includes a rectangular lower end peripheral portion 28 defining the bottom opening 26. The lower end peripheral portion 28 is configured to substantially correspond to a rectangular peripheral edge of the upper wall 11 of the vehicle panel 1. Further, the console box main body 20 includes a pair of (right and left) elongated contacting portions 29 formed in the lower end peripheral portion 28. The contacting portions 29 are respectively elongated in the front-back direction so as to extend along the left wall 23 and the right wall 24. Further, the contacting portions 29 include a plurality of (in groups of four in this embodiment) engagement projections 30 formed in inner surfaces thereof. The engagement projections 30 are arranged and spaced apart in a longitudinal direction of each of the contacting portions 29 at intervals. Further, the console box main body 20 includes first insertion holes 31 and second insertion holes 32. The first insertion holes 31 and the second insertion holes 32 are formed in in pairs and positioned at the four corners of the lower end peripheral portion 28 of the console box main body 20.

As shown in FIGS. 3 and 4, the console box main body 20 includes a pair of (right and left) elongated engagement members 33 formed in the lower end peripheral portion 28 thereof and extending in the front-back direction. The engagement members 33 are positioned laterally opposite each other on the inner side relative to the contacting portions 29. The engagement members 33 are oriented horizontally and parallel to the contacting portions 29. Further, the engagement members 33 are movably or rotatably connected to the lower end peripheral portion 28 via hinges 41 (i.e., movably connecting mechanisms 40) so as to move or rotate outward.

As shown in FIG. 3, the engagement members 33 are configured to engage and mate with corresponding openings 12 formed in the vehicle panel 1 when the console box main body 20 (the console box 2) is disposed on the vehicle panel 1. In particular, the engagement members 33 have lengths substantially equal to or slightly smaller than lengths of peripheral edges 13 of the openings 12. Further, as shown in FIG. 4, the engagement members 33 include flat plate-shaped base portions 34, angled or bent plate-shaped functional portions 35, and flat plate-shaped engagement portions 36. The base portions 34 are connected to the hinges 41 at proximal portions (not labeled) thereof. The functional portions 35 are continuous with distal portions (not labeled) of the base portions 34 while being inclined upward with respect to the base portions 34. Further, the engagement portions 36 are continuous with and orthogonal to the distal portions of the base portions 34.

Further, as shown in FIG. 4, the engagement members 33 have a plurality of (in groups of four in this embodiment) engagement holes 37 formed in the base portions 34 and penetrating the base portions 34 in the thickness directions. The engagement holes 37 are arranged at intervals in a longitudinal direction of each of the engagement members 33 (the base portions 34). In particular, the engagement holes 37 are arranged so as to correspond to the engagement projections 30 of the contacting portions 29 when the engagement members 33 rotate outward. That is, the engagement holes 37 are configured such that the engagement projections 30 of the contacting portions 29 can closely fit therein when the engagement members 33 rotate outward.

As shown in FIGS. 3 and 4, the bottom member 50 is a rectangular plate-shaped member corresponding to the bottom opening 26 of the console box main body 20. In particular, the bottom member 50 is configured to fit in the lower end peripheral portion 28 (the bottom opening 26) of the console box main body 20 so as to close the bottom opening 26. Further, the bottom member 50 includes first engagement legs 51 and second engagement legs 52 formed in a lower surface thereof and projecting downward. The first engagement legs 51 and the second engagement legs 52 are formed in four corners of the bottom member 50 in pairs, so as to correspond to the first insertion holes 31 and the second insertion holes 32 formed in the lower end peripheral portion 28 of the console box main body 20.

As shown in FIGS. 2 to 4, the first engagement legs 51 include engagement claws, i.e., first engagement claws 51a and second engagement claws 51b, formed on the outer surfaces thereof. The first engagement claw 51a and the second engagement claw 51b of each of the first engagement legs 51 are arranged in series in a longitudinal or vertical direction of each of the first engagement legs 51. Further, the first engagement claw 51a and the second engagement claw 51b of each of the first engagement legs 51 are configured to engage a corresponding first insertion hole 31 of the console box main body 20.

As shown in FIGS. 2 to 4, the second engagement legs 52 respectively include engagement claws 52a formed on the outer surfaces thereof. The engagement claw 52a of each of the second engagement legs 52 is configured to engage a corresponding second insertion hole 32 of the console box main body 20.

As shown in FIGS. 2 to 4, the bottom member 50 includes a plurality of (six in this embodiment) pressing members or projections 53 formed in the lower surface thereof and projecting downward. The projections 53 are preferably arranged in series along right and left peripheries of the bottom member 50 in groups of three, so as to correspond to the engagement members 33 of the console box main body 20. Further, the projections 53 have outer linear vertical surfaces 54 and inclined surfaces 55. The vertical surface 54 of each of the projections 53 vertically extends from a proximal end (not labeled) of each of the projections 53. The inclined surface 55 of each of the projections 53 is continuous with the vertical surface 54 and extends obliquely inward toward a distal ends (not labeled) of each of the projections 53.

Next, a (normal) method of attaching the console box 2 to the vehicle panel 1 will now be described in detail with reference to FIGS. 4 to 8.

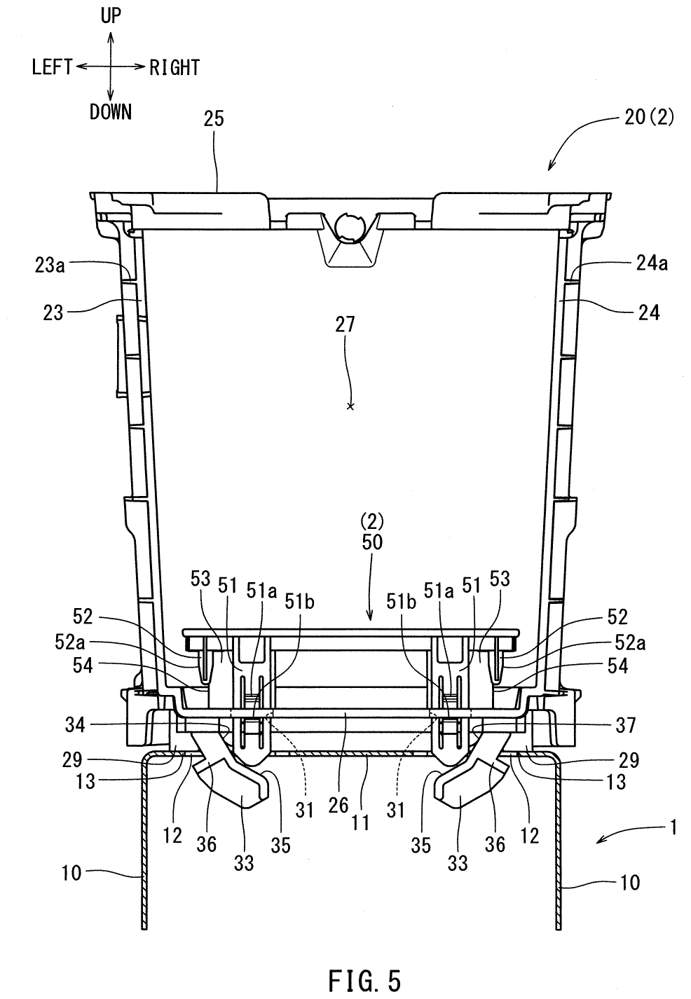

First, in a condition shown in FIG. 4, the bottom member 50 is introduced into an interior 27 of the console box main body 20 from above with the first engagement legs 51 and the second engagement legs 52 vertically aligned with the corresponding first insertion holes 31 and the second insertion holes 32 formed in the lower end peripheral portion 28 of the console box main body 20. Thereafter, as shown in FIG. 5, the bottom member 50 is pressed into the bottom opening 26 of the console box main body 20 until the first engagement claws 51a or the second engagement claws 51b of the first engagement legs 51 engage the first insertion holes 31 of the console box main body 20 (FIG. 5 shows a condition in which the second engagement claws 51b engage the first insertion holes 31), which will be referred to as a first operation. As a result, the bottom member 50 is partly fitted in the bottom opening 26, so as to be partly coupled to the console box main body 20. Thus, the console box 2 is partly assembled or formed, which may be referred to as a partly assembled condition of the console box 2.

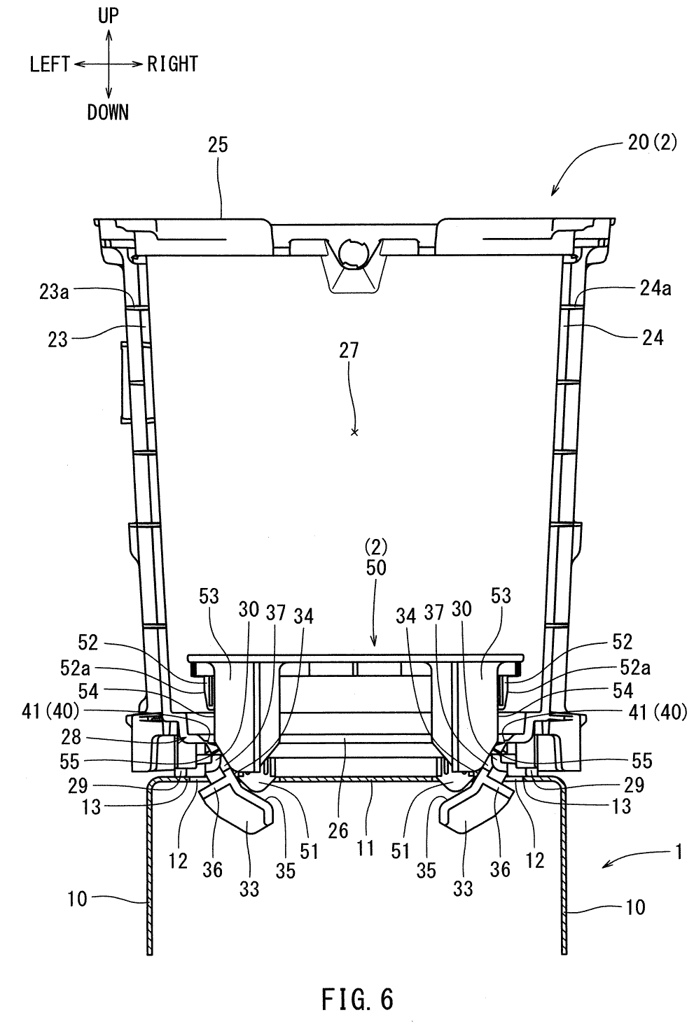

Next, in the first operation, the inclined surfaces 55 of the projections 53 formed in the right and left peripheries of the bottom member 50 contact or act on the base portions 34 of the engagement members 33 of the console box main body 20, thereby pressing the engagement members 33 downward (FIG. 6). As a result, the engagement members 33 are rotated outward by a certain angle via the hinges 41, so that the engagement portions 36 of the engagement members 33 are rotated toward the contacting portion 29. Further, the engagement members 33 partly project downward beyond the bottom opening 26 of the console box main body 20 due to rotation thereof.

As shown in FIGS. 5 and 6, the console box main body 20 to which the bottom member 50 is partly coupled is then disposed on the upper wall 11 of the vehicle panel 1 with the contacting portions 29 of the console box main body 20 positioned along the outer peripheral edges 13 of the openings 12 formed in the upper wall 11 of the vehicle panel 1, which will be referred to as a second operation. Further, in such a condition in which the console box main body 20 is disposed on the upper wall 11 of the vehicle panel 1, the engagement members 33 are protruded into the openings 12 as the engagement members 33 are partly projected downward beyond the bottom opening 26 of the console box main body 20.

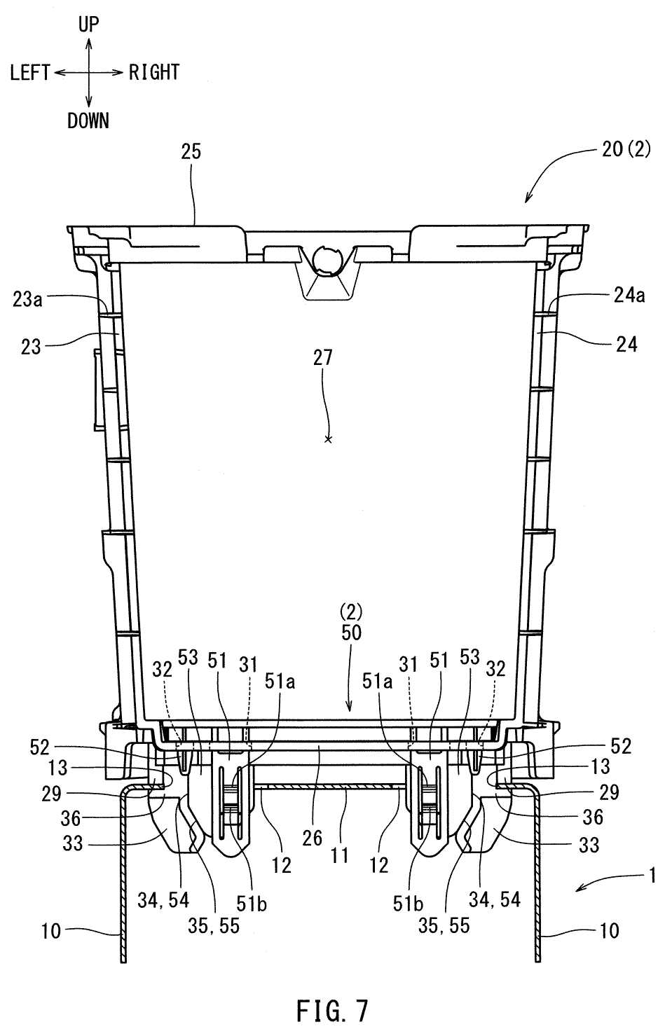

Subsequently, the bottom member 50, which is partly coupled to the console box main body 20, is further pressed into the bottom opening 26 of the console box main body 20 until the bottom member 50 contacts or engages the lower end peripheral portion 28, which will be referred to as a third operation. As a result, the engagement claws 52a formed in the second engagement legs 52 engage the second insertion holes 32 of the console box main body 20 while the supplemental engagement claws 51b of the first engagement legs 51 are disengaged from the first insertion holes 31 of the console box main body 20 (FIG. 7). In addition, the bottom member 50 is (fully) fitted in the bottom opening 26, so as to be (fully) coupled to the console box main body 20. Thus, the console box 2 is (fully) assembled or formed on the upper wall 11 of the vehicle panel 1.

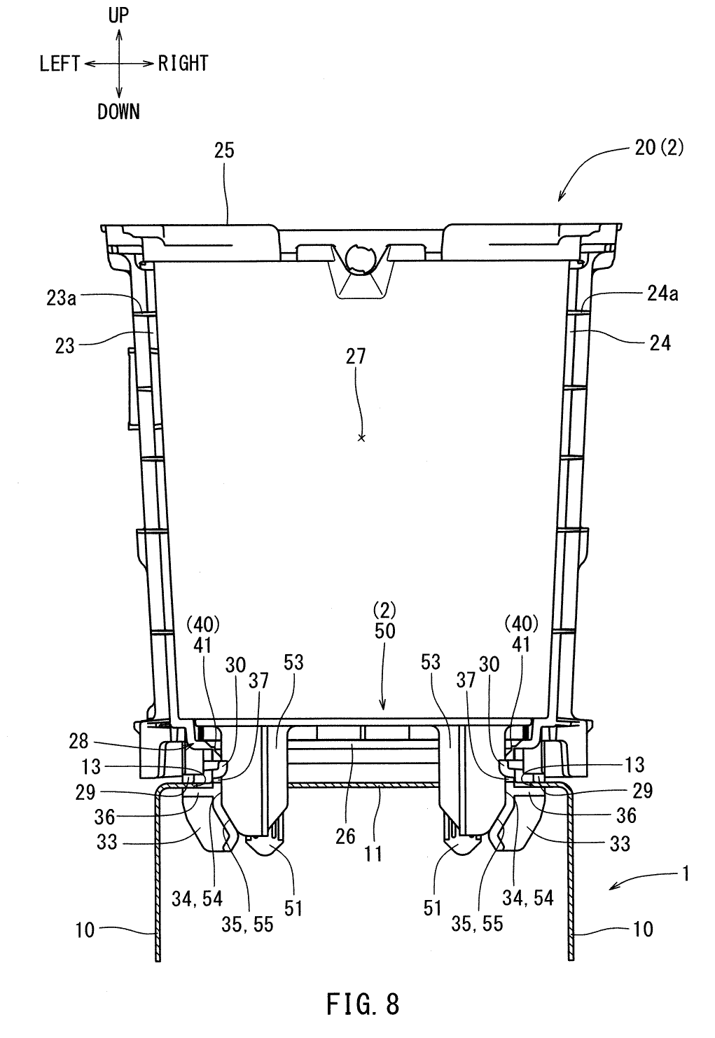

Further, in the third operation, the vertical surfaces 54 and the inclined surfaces 55 of the projections 53 formed in the bottom member 50 contact or act on the base portions 34 and the functional portions 35 of the engagement members 33, thereby further pressing the engagement members 33 downward (FIG. 8). As a result, the engagement members 33 are further rotated outward by a certain angle, and more specifically, so as to be rotated a total of 90 degrees. Upon rotation of the engagement member 33, the engagement portions 36 of the engagement members 33 are further rotated toward the contacting portions 29 so as to be positioned vertically opposite to the contacting portions 29. As a result, the engagement portions 36 of the engagement members 33 contact the outer peripheral edges 13 of the openings 12 formed in the vehicle panel 1, thereby pressing the outer peripheral edges 13 of the openings 12 from below. As a result, the outer peripheral edges 13 of the openings 12 are sandwiched or pinched between the engagement portions 36 of the engagement members 33 and the contacting portions 29 positioned on the outer peripheral edges 13, thereby connecting the console box main body 20 (the console box 2) to the vehicle panel 1. Thus, the console box 2 is attached to the vehicle panel 1 simultaneously with formation or assembly thereof.

Further, as shown in FIGS. 7 and 8, in a condition in which the engagement members 33 are rotated 90 degrees, the vertical surfaces 54 and the inclined surfaces 55 of the projections 53 formed in the bottom member 50 closely contact the base portions 34 and the functional portions 35 of the engagement members 33. Therefore, the engagement members 33 are stably held in the rotated position. As a result, the engagement portions 36 of the engagement members 33 reliably and stably press the outer peripheral edges 13 of the openings 12 formed in the vehicle panel 1. That is, the outer peripheral edges 13 of the openings 12 are securely sandwiched between the engagement portions 36 of the engagement members 33 and the contacting portions 29 formed in the console box main body 20. Thus, the console box 2 is reliably and stably attached to the vehicle panel 1 without producing any rattling in vertical and horizontal directions.

Further, as shown in FIG. 8, in the condition in which the engagement members 33 are rotated 90 degrees, the engagement projections 30 formed in the contacting portions 29 of the console box main body 20 engage or fit in the engagement holes 37 formed in the engagement members 33. This may contribute to increase of stability of the engagement members 33 in the rotated position. Therefore, rattling of the console box 2 with respect to the vehicle panel 1 may be minimized. Further, such a structure may effectively prevent the hinges 41 from being subjected to an excessive load in the vertical direction. Therefore, the hinges 41 may be prevented from being damaged.

Further, as previously described, the engagement members 33 have elongated shapes and have the lengths slightly smaller than the lengths of the outer peripheral edges 13 of the openings 12. This means that the engagement members 33 can engage the outer peripheral edges 13 of the openings 12 over the substantially entire length of the outer peripheral edges 13 of the openings 12. Therefore, the engagement members 33 are stably held in the rotated position, thereby reducing rattling of the console box 2 with respect to the vehicle panel 1.

Further, according to this embodiment, the console box main body 20 can be disposed on the upper wall 11 of the vehicle panel 1 with the bottom member 50 partly coupled thereto. Therefore, the console box 2 can be smoothly and quickly assembled or formed on and attached to the vehicle panel 1. Further, the engagement members 33 are connected to the console box main body 20 via the hinges 41. Therefore, the engagement members 33 can be formed integrally with the console box main body 20 by integral molding of the synthetic resin.

In this embodiment, the partly assembled condition of the console box 2 may be omitted. In such a modified method, first, only the console box main body 20 is disposed on the upper wall 11 of the vehicle panel 1 with the contacting portions 29 formed in the console box main body 20 respectively positioned along the outer peripheral edges 13 of the openings 12 formed in the upper wall 11 of the vehicle panel 1. Thereafter, the bottom member 50 is directly pressed into the bottom opening 26 of the console box main body 20 until the bottom member 50 contacts or engages the lower end peripheral portion 28. As a result, the console box 2 is assembled or formed on the upper wall 11 of the vehicle panel 1. Simultaneously, the console box 2 is attached to the vehicle panel 1 in the same manner as the normal method described above. Thus, the console box 2 is attached to the vehicle panel 1 simultaneously with formation or assembly thereof. Further, in the modified method, the first engagement legs 51 formed in the bottom member 50 are not substantially utilized.

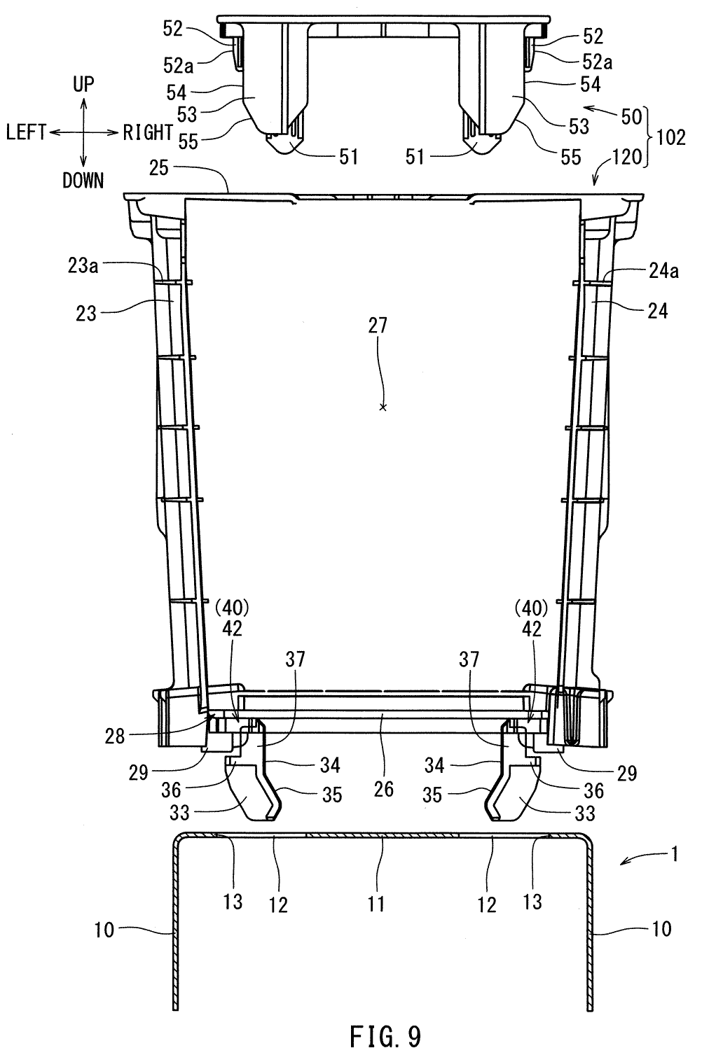

Next, a second embodiment will be described in detail with reference to FIGS. 9 to 11. Because the second embodiment relates to the first embodiment, only the constructions and elements that are different from the first embodiment will be explained in detail. Elements that are the same in the first and second embodiments will be identified by the same reference numerals and a detailed description of such elements may be omitted or simplified.

In the second embodiment, the console box 2 of the first embodiment is changed to a consoled box 102 having a console box main body 120. The console box 102 (the console box main body 120) is different from the console box 2 (the console box main body 20) in that the movable connecting mechanism 40 is changed from the hinges 41 to sliding devices 42. That is, the engagement members 33 (which are formed separately from the console box main body 20) are movably or slidably connected to the lower end peripheral portion 28 via the sliding devices 42 so as to move or slide in a lateral direction. Further, unlike the first embodiment, the engagement members 33 are vertically positioned in parallel to the contacting portions 29. Therefore, the engagement members 33 normally project downward beyond the bottom opening 26 of the console box main body 120.

Next, a method of attaching the console box 102 to the vehicle panel 1 will now be described in detail with reference to FIGS. 9 to 11.

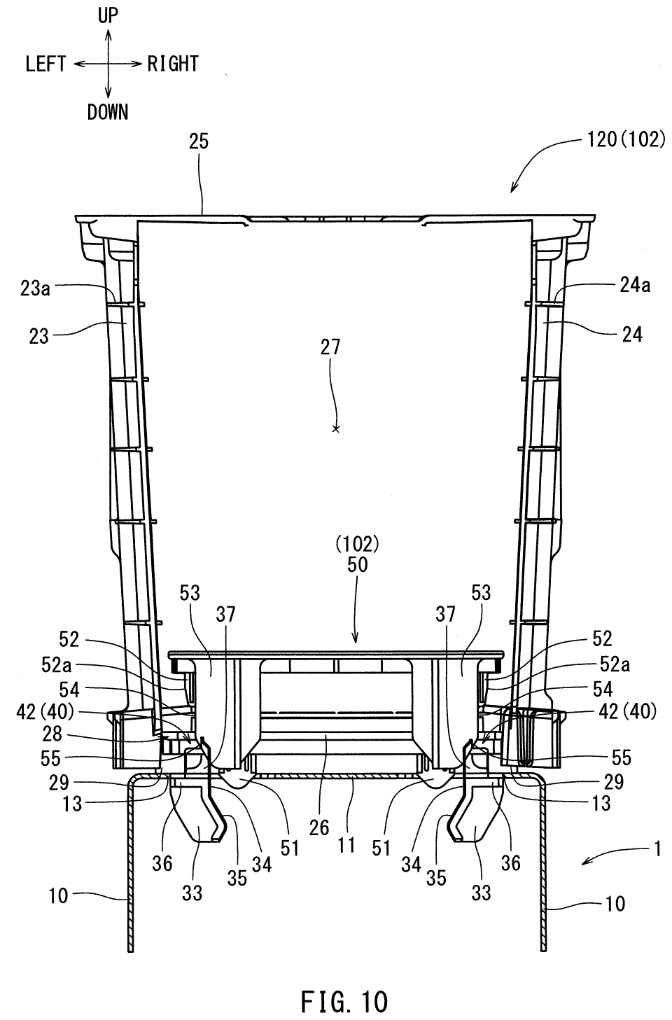

First, in a condition shown in FIG. 9, the first operation is performed in the same manner as previously described with respect to the first embodiment. As a result, the bottom member 50 is partly fitted in the bottom opening 26 of the console box main body 120 (FIG. 10), so as to be partly coupled to the console box main body 120. Thus, the console box 102 is partly assembled or formed, which may be referred to as a partly assembled condition of the console box 102. However, unlike the first embodiment, in the first operation, the inclined surfaces 55 of the projections 53 formed in the right and left peripheries of the bottom member 50 contact the base portions 34 of the engagement members 33 of the console box main body 120, thereby pressing the engagement members 33 laterally outward (FIG. 10). As a result, the engagement members 33 are slid laterally outward by a certain distance via the sliding devices 42.

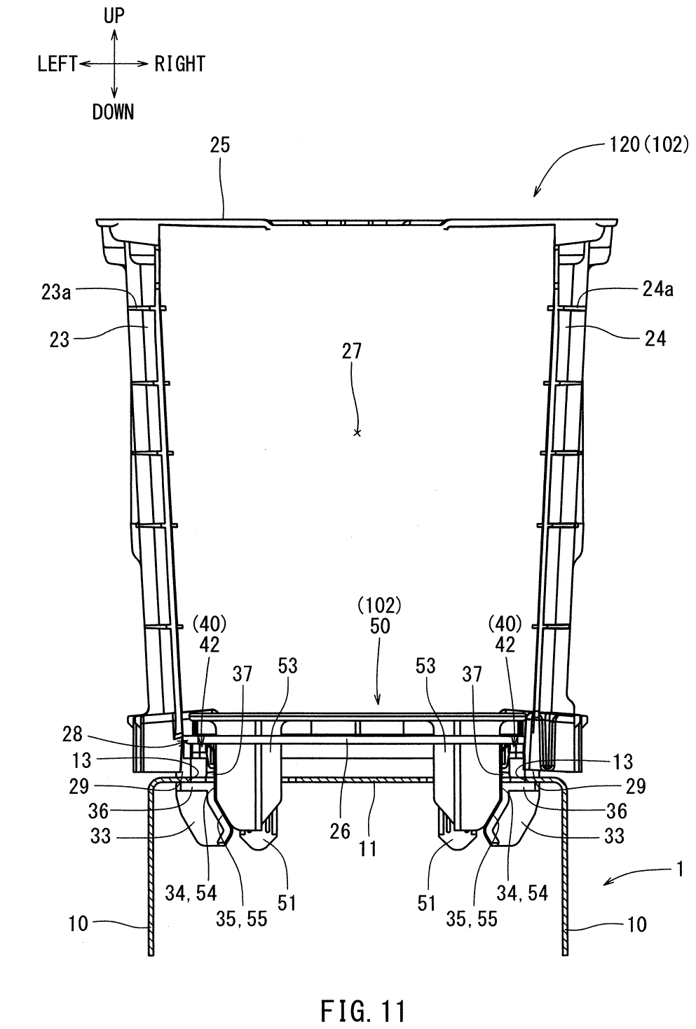

Thereafter, the second operation and the third operation are successively performed in the same manner as previously described with respect to the first embodiment. As a result, the bottom member 50 is (fully) fitted in the bottom opening 26, so as to be (fully) coupled to the console box main body 120. Thus, the console box 102 is (fully) formed or assembled on the upper wall 11 of the vehicle panel 1. However, unlike the first embodiment, in the third operation, the projections 53 formed in the bottom member 50 further press the engagement members 33 formed in the console box main body 120 laterally outward (FIG. 11). As a result, the engagement members 33 are further slid laterally outward by a certain distance, and more specifically, so as to be slid by a predetermined distance in total. Upon sliding of the engagement member 33, the engagement portions 36 of the engagement members 33 are further slid toward the contacting portions 29 so as to be positioned vertically opposite to the contacting portions 29. As a result, the engagement portions 36 of the engagement members 33 contact the outer peripheral edges 13 of the openings 12 formed in the vehicle panel 1, thereby pressing the outer peripheral edges 13 of the openings 12 from below. In addition, similar to the first embodiment, the outer peripheral edges 13 of the openings 12 are sandwiched between the engagement portions 36 of the engagement members 33 and the contacting portions 29 formed in the console box main body 20, thereby connecting the console box main body 120 (the console box 102) to the vehicle panel 1. Thus, the console box 102 is attached to the vehicle panel 1 simultaneously with formation or assembly thereof.

Naturally, various changes and modifications may be made to the first and second embodiments. For example, in the embodiments, each of the engagement members 33 is a single elongated member. However, each of the engagement members 33 may be divided into a plurality of segments or parts (e.g., two parts) as necessary. Further, in the embodiments, the contacting portions 29 include the engagement projections 30 while the engagement members 33 have the engagement holes 37. However, the contacting portions 29 may include the engagement holes 37 while the engagement members 33 may have the engagement projections 30.

Further, in the embodiments, the console box 2, 102 is shown as an example of the vehicle interior part. However, the vehicle interior part may be a glove compartment, an interior trim or other such components.

Representative examples of the present disclosure have been described in detail with reference to the attached drawings. This detailed description is merely intended to teach a person of skill in the art further details for practicing preferred aspects of the present disclosure and is not intended to limit the scope of the disclosure. Only the claims define the scope of the claimed disclosure. Therefore, combinations of features and steps disclosed in the foregoing detail description may not be necessary to practice the disclosure in the broadest sense, and are instead taught merely to particularly describe detailed representative examples of the disclosure. Moreover, the various features taught in this specification may be combined in ways that are not specifically enumerated in order to obtain additional useful embodiments of the present disclosure.

What is claimed is:

1. A vehicle interior part attaching structure for attaching a vehicle interior part to a vehicle structural component, the vehicle interior part attaching structure comprising:
a pair of openings in the vehicle structural component, wherein the openings are defined by a plurality of peripheral edges of the vehicle structural component; and
a box-shaped interior part main body and a bottom plate defining the vehicle interior part,
wherein the interior part main body has a bottom opening, a pair of contacting portions, and a pair of engagement members having engagement portions,
wherein the engagement members are movably connected to the interior part main body so as to be configured to move outward,
wherein the bottom plate is configured to fit in the bottom opening of the interior part main body,
wherein the bottom plate includes a plurality of pressing members, and
wherein the pressing members are configured to move the engagement members outward when the bottom plate is fitted in the bottom opening of the interior part main body in a condition in which the interior part main body is disposed on the vehicle structural component, thereby bringing the engagement portions of the engagement members into contact with the peripheral edges of the openings in the vehicle structural component such that the peripheral edges of the openings are sandwiched between the engagement portions and the contacting portions.

2. The vehicle interior part attaching structure of claim 1, wherein the openings have elongated rectangular shapes, and
wherein the engagement members have lengths substantially equal to lengths of the peripheral edges defining the openings.

3. The vehicle interior part attaching structure of claim 2, wherein each of the engagement members is divided into a plurality of parts.

4. The vehicle interior part attaching structure of claim 1, wherein the interior part main body includes a plurality of first insertion holes,
wherein the bottom plate includes a plurality of first engagement legs having a plurality of engagement claws, and
wherein the first engagement legs are configured such that the engagement claws of the first engagement legs engage the first insertion holes when the bottom plate is partly fitted in the bottom opening of the interior part main body.

5. The vehicle interior part attaching structure of claim 4, wherein the interior part main body includes a plurality of second insertion holes,
wherein the bottom plate includes a plurality of second engagement legs having a plurality of engagement claws, and
wherein the second engagement legs are configured such that the engagement claws of the second engagement legs engage the second insertion holes when the bottom plate is fitted in the bottom opening of the interior part main body.

6. The vehicle interior part attaching structure of claim 1, wherein the engagement members are rotatably coupled to the vehicle interior part via hinges so as to rotate outward.

7. The vehicle interior part attaching structure of claim 1, wherein the engagement members are slidably coupled to the vehicle interior part so as to slide outward.

8. The vehicle interior part attaching structure of claim 1, wherein each of the contacting portions includes a plurality of engagement projections,
wherein each of the engagement members includes a plurality of engagement holes formed therein, and
wherein the engagement projections are configured to fit in the engagement holes when the engagement portions of the engagement members are brought into contact with the peripheral edges of the openings.

9. A vehicle interior part, comprising:
a box-shaped interior part main body; and
a bottom plate,
wherein the interior part main body has a bottom opening, a contacting portion, and an engagement member having an engagement portion,
wherein the engagement member is movably coupled to the interior part main body,
wherein the bottom plate is configured to fit in the bottom opening of the interior part main body,
wherein the bottom plate includes a pressing member, and
wherein the pressing member is configured to act on the engagement member to move the engagement portion toward the contacting portion when the bottom plate is fitted in the bottom opening of the interior part main body.
